(19) United States
(12) Patent Application Publication
(10) Pub. No.: US 2025/0118487 A1
(43) Pub. Date: Apr. 10, 2025

(54) COIL COMPONENT

(71) Applicant: SAMSUNG ELECTRO-MECHANICS CO., LTD., Suwon-si (KR)

(72) Inventors: Sang Jin Kim, Suwon-si (KR); Byeong Cheol Moon, Suwon-si (KR); Han Lee, Suwon-si (KR); Boum Seock Kim, Suwon-si (KR)

(73) Assignee: SAMSUNG ELECTRO-MECHANICS CO., LTD., Suwon-si (KR)

(21) Appl. No.: 18/902,018

(22) Filed: Sep. 30, 2024

(30) Foreign Application Priority Data
Oct. 6, 2023 (KR) 10-2023-0133449
Dec. 14, 2023 (KR) 10-2023-0181688

(51) Int. Cl. H01F 27/32; H01F 1/147; H01F 1/20; H01F 27/02; H01F 27/29

(52) U.S. Cl. CPC H01F 27/323; H01F 1/14766; H01F 1/20; H01F 27/022; H01F 27/292

(57) ABSTRACT

A coil component includes a body; a first wound coil including a first coil portion, and first and second lead-out portions; a second wound coil including a second coil portion, and third and fourth lead-out portions; a coupling adjustment portion including a first region through which a winding axis of the first coil portion and a winding axis of the second coil portion pass, and a second region surrounding the first region in a lateral direction; first and second external electrodes respectively connected to the first and second lead-out portions; and third and fourth external electrodes respectively connected to the third and fourth lead-out portions, wherein the first region and the second region include a plurality of magnetic particles and an insulating material interposed between the plurality of magnetic particles, respectively, and magnetic permeability of the first region is different from magnetic permeability of the second region.

### CROSS-REFERENCE TO RELATED APPLICATION(S)

The present application claims the benefit of priority to Korean Patent Application No. 10-2023-0133449 filed on Oct. 6, 2023 and Korean Patent Application No. 10-2023-0181688 filed on Dec. 14, 2023 in the Korean Intellectual Property Office, the entire disclosures of which are incorporated herein by reference.

### TECHNICAL FIELD

The present disclosure relates to a coil component.

### BACKGROUND

As electronic devices such as digital TVs, mobile phones, laptops, etc. are miniaturized and thinned, miniaturization and thinning of coil components applied to electronic devices are also required. To meet the requirements, research and development of various wound type or thin film type coil components are actively underway.

Main issues with the miniaturization and thinning of coil components lie in obtaining equivalent characteristics of conventional coil components while also achieving such miniaturization and thinning of the products. In order to meet these requirements, a ratio of a magnetic material in a core filled with the magnetic material should be increased, but there may be a limit to increasing the ratio due to changes in frequency characteristics or the like, depending on strength and insulation of a body of an inductor.

Meanwhile, there is a growing demand for an array-type coil component having advantages of, e.g., reducing a mounting area of a coil component. The array-type coil component may be determined as a non-coupled inductor, a coupled inductor, or a mixed inductor thereof, depending on a coupling coefficient or mutual inductance between a plurality of coils. In such an array-type inductor, it is necessary to secure characteristics such as saturation current (Iₛₐₜ) or the like while achieving a target coupling coefficient.

### SUMMARY

According to one aspect of the present disclosure, a coil component suitable for effectively implementing a target coupling coefficient and improving characteristics such as saturation current (Iₛₐₜ) or the like may be provided.

According to an aspect of the present disclosure, a coil component includes a body having an upper surface and a lower surface, opposite to each other, in a first direction, and a side surface connecting the upper surface and the lower surface; a first wound coil disposed in the body, and including a first coil portion having at least one turn, and first and second lead-out portions respectively extending from both end portions of the first coil portion; a second wound coil disposed in the body, spaced apart from the first wound coil in the first direction, and including a second coil portion having at least one turn, and third and fourth lead-out portions respectively extending from both end portions of the second coil portion; a coupling adjustment portion having a portion disposed between the first and second wound coils, and including a first region through which a winding axis of the first coil portion and a winding axis of the second coil portion pass, and a second region surrounding the first region in a lateral direction which is different from the first direction; first and second external electrodes respectively connected to the first and second lead-out portions; and third and fourth external electrodes respectively connected to the third and fourth lead-out portions, in which the first region and the second region includes a plurality of magnetic particles and an insulating material interposed between the plurality of magnetic particles, respectively, and magnetic permeability of the first region is different from magnetic permeability of the second region.

In an embodiment, the magnetic permeability of the first region may be higher than the magnetic permeability of the second region.

In an embodiment, a packing rate of the magnetic particles of the first region may be higher than a packing rate of the magnetic particles of the second region.

In an embodiment, a difference in D50 value between the magnetic particles in the first region and the magnetic particles in the second region may be 10% or less.

In an embodiment, the first region may include a first magnetic particle having a diameter range of 5 to 61 μm, a second magnetic particle having a diameter range of 0.9 to 4.5 μm, and a third magnetic particle having a diameter range of 10 to 800 nm, and the second region may include a first magnetic particle having a diameter range of 5 to 61 μm, and a second magnetic particle having a diameter range of 0.9 to 4.5 μm.

In an embodiment, the first region may be integrated with the body.

In an embodiment, the second region may cover at least a portion of a side surface of the first coil portion.

In an embodiment, the second region may be spaced apart from a side surface of the first coil portion.

In an embodiment, second region may cover at least a portion of a side surface of the second coil portion.

In an embodiment, the second region may be spaced apart from a side surface of the second coil portion.

In an embodiment, the second region may cover at least a portion of a side surface of the first coil portion and at least a portion of a side surface of the second coil portion.

In an embodiment, the second region may be disposed outside of the first coil portion and the second coil portion.

In an embodiment, the second region may extend to the side surface of the body.

In an embodiment, the second region may be disposed in a region in which the first and second coil portions overlap in the first direction.

In an embodiment, the second region may protrude from inner surfaces of the first and second coil portions toward the winding axis of the first and second coil portions.

In an embodiment, on a cross-section parallel to the first direction, the first and second coil portions may have an aspect ratio of less than 1.

In an embodiment, on a cross-section parallel to the first direction, the first and second coil portions may have an aspect ratio of 1 or more.

In an embodiment, on a cross-section parallel to the first direction, the first and second coil portions may be circular.

In an embodiment, on a cross-section parallel to the first direction, the first and second coil portions may be rectangular.

In an embodiment, on a cross-section parallel to the first direction, the first and second coil portions may be inclined with respect to the first direction.

In an embodiment, the second region may be spaced apart from the first and second coil portions.

In an embodiment, the body may include a mold portion in which the first and second wound coils may be disposed and protrudes toward the upper surface of the body.

In an embodiment, the mold portion may include a base portion on which the second wound coil may be directly disposed, and a core portion protruding from the base portion and penetrating central portions of the first and second coil portions, and a gap between the core portion and the upper surface of the body may be narrower than a gap between the first coil portion and the upper surface of the body.

According to an aspect of the present disclosure, a coil component includes a body having an upper surface and a lower surface, opposite to each other, in a first direction, and a side surface connecting the upper surface and the lower surface; a first wound coil disposed in the body, and including a first coil portion having at least one turn, and first and second lead-out portions respectively extending from both end portions of the first coil portion; a second wound coil disposed in the body, spaced apart from the first wound coil in the first direction, and including a second coil portion having at least one turn, and third and fourth lead-out portions respectively extending from both end portions of the second coil portion; a coupling adjustment portion having a portion disposed between the first and second wound coils, and including a first region through which a winding axis of the first coil portion and a winding axis of the second coil portion pass, and a second region surrounding the first region in a lateral direction which is different from the first direction; first and second external electrodes respectively connected to the first and second lead-out portions; and third and fourth external electrodes respectively connected to the third and fourth lead-out portions, in which the first region and the second region includes magnetic particles, and a packing rate of the magnetic particles of the first region is different from a packing rate of the magnetic particles of the second region.

In an embodiment, the packing rate of the magnetic particles of the first region may be higher than the packing rate of the magnetic particles of the second region.

In an embodiment, the number of types of the magnetic particles included in the first region may be greater than the number of types of magnetic particles included in the second region.

In an embodiment, the first region may be integrated with the body.

In an embodiment, the second region may cover a side surface of the first coil portion and at least a portion of a side surface of the second coil portion.

In an embodiment, the second region may be disposed outside of the first coil portion and the second coil portion.

In an embodiment, the second region may protrude from inner surfaces of the first and second coil portions toward the winding axis of the first and second coil portions.

According to an aspect of the present disclosure, a coil component includes a body having an upper surface and a lower surface, opposite to each other, in a first direction, and a side surface connecting the upper surface and the lower surface; a first wound coil disposed in the body, and including a first coil portion having at least one turn, and first and second lead-out portions respectively extending from both end portions of the first coil portion; a second wound coil disposed in the body, spaced apart from the first wound coil in the first direction, and including a second coil portion having at least one turn, and third and fourth lead-out portions respectively extending from both end portions of the second coil portion; a coupling adjustment portion having a portion disposed between the first and second wound coils, and including a first region through which a winding axis of the first coil portion and a winding axis of the second coil portion pass, and a second region surrounding the first region in a lateral direction which is different from the first direction; first and second external electrodes respectively connected to the first and second lead-out portions; and third and fourth external electrodes respectively connected to the third and fourth lead-out portions, in which the coupling adjustment portion includes an Fe-based alloy, and a composition of the Fe-based alloy included in the first region is different from a composition of the Fe-based alloy included in the second region.

In an embodiment, an Fe amount of the Fe-based alloy included in the first region may be higher than an Fe amount of the Fe-based alloy included in the second region.

In an embodiment, the Fe-based alloy may be an Fe—Si-based alloy, and an Si amount of the Fe—Si-based alloy included in the first region may be higher than an Si amount of the Fe—Si-based alloy included in the second region.

In an embodiment, the Si amount in the Fe—Si-based alloy included in the first region may be 6.5 wt % or more, and the Si amount in the Fe—Si-based alloy included in the second region may be less than 6.5 wt %.

In an embodiment, the Si amount of the Fe—Si-based alloy included in the second region may be 1 wt % or more and 5 wt % or less.

According to an aspect of the present disclosure, a coil component includes a body; a first wound coil disposed in the body, and including a first coil portion having at least one turn, and first and second lead-out portions respectively extending from both end portions of the first coil portion; a second wound coil disposed in the body, spaced apart from the first wound coil in the first direction, and including a second coil portion having at least one turn, and third and fourth lead-out portions respectively extending from both end portions of the second coil portion; a coupling adjustment portion having a portion disposed between the first and second wound coils, and including a first region through which a winding axis of the first coil portion and a winding axis of the second coil portion pass, and a second region surrounding the first region in a lateral direction which is different from the first direction; first and second external electrodes respectively connected to the first and second lead-out portions; and third and fourth external electrodes respectively connected to the third and fourth lead-out portions, in which the first region and the second region includes magnetic particles, and the number of types of the magnetic particles included in the first region is greater than the number of types of magnetic particles included in the second region.

In one embodiment, magnetic permeability of the first region may be higher than magnetic permeability of the second region.

In one embodiment, a packing rate of the magnetic particles of the first region may be higher than a packing rate of the magnetic particles of the second region.

According to an aspect of the present disclosure, a coil component includes a magnetic body; a first wound coil disposed in the magnetic body, and including a first coil portion having at least one turn, and first and second lead-out portions respectively extending from both end portions of the first coil portion; a second wound coil disposed in the magnetic body, spaced apart from the first wound coil in the first direction, and including a second coil portion having at least one turn, and third and fourth lead-out portions respectively extending from both end portions of the second coil portion; first and second external electrodes respectively connected to the first and second lead-out portions; and third and fourth external electrodes respectively connected to the third and fourth lead-out portions, in which magnetic permeability in a central region of the magnetic body through which a winding axis of the first coil portion and a winding axis of the second coil portion pass is greater than magnetic permeability in at least one of a gap region between the first and second wound coils in the first direction or an outer region of the first and second wound coils in a lateral direction different from the first direction.

In one embodiment, the magnetic body may include a plurality of magnetic particles, and a packing rate of the magnetic particles of the central region may be higher than a packing rate of the magnetic particles of at least one of the gap region or the outer region.

In one embodiment, the magnetic permeability in the central region may be greater than the magnetic permeability of the gap region.

In one embodiment, the magnetic permeability in the central region may be greater than the magnetic permeability of the outer region.

In one embodiment, the magnetic permeability in the central region may be greater than the magnetic permeability of the gap region and the magnetic permeability of the outer region.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a transparent perspective view schematically illustrating a coil component according to a first embodiment of the present disclosure.

FIG. 2 is an exploded perspective view of a coil and a coupling adjustment portion in the coil component of FIG. 1.

FIG. 3 is a cross-sectional view of the coil component of FIG. 1.

FIG. 4 is an enlarged cross-sectional view of a first region of a coupling adjustment portion.

FIG. 5 is an enlarged cross-sectional view of a second region of a coupling adjustment portion.

FIG. 6 is an enlarged cross-sectional view of a first region of a coupling adjustment portion in a modified example.

FIG. 7 is an enlarged cross-sectional view of a first region of a coupling adjustment portion in a modified example.

FIG. 8 is an enlarged cross-sectional view of a second region of a coupling adjustment portion in a modified example.

FIGS. 9 through 20 illustrate coil components according to modified examples.

FIGS. 21 through 24 illustrate an exemplary method for manufacturing coil components.

### DETAILED DESCRIPTION

Hereinafter, embodiments of the present disclosure will be described with reference to specific embodiments and the accompanying drawings. However, an embodiment of the present disclosure may be modified to have various other forms, and the scope of the present disclosure is not limited to embodiments described below. Further, embodiments of the present disclosure may be provided in order to more completely explain the present disclosure to those skilled in the art. Accordingly, shapes and sizes of components in the drawings may be exaggerated for clearer description, and components indicated by the same reference numerals in the drawings may be the same elements.

Various types of electronic components may be used in electronic devices, and various types of coil components may be appropriately used among these electronic components for purposes such as noise removal. In other words, coil components in electronic devices may be used as power inductors, HF inductors, general beads, GHz beads, common mode filters, or the like.

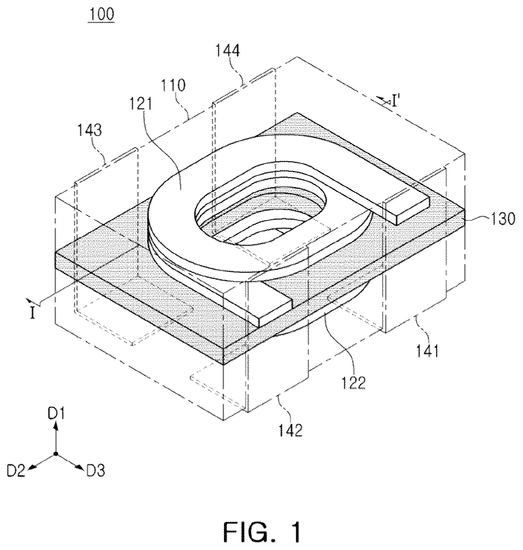

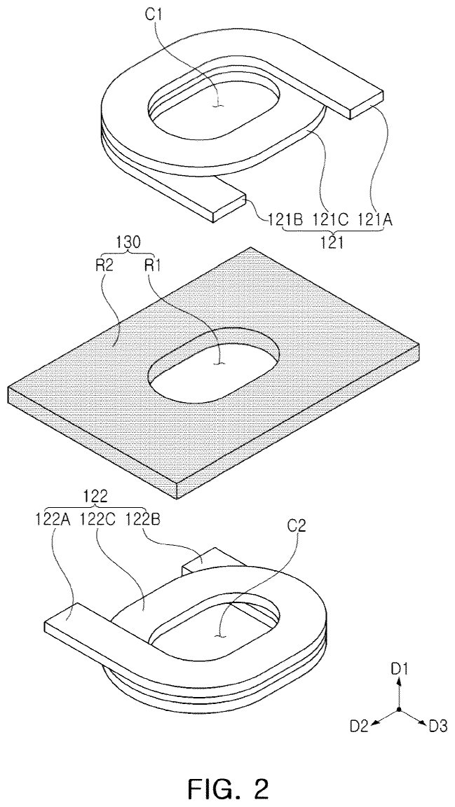

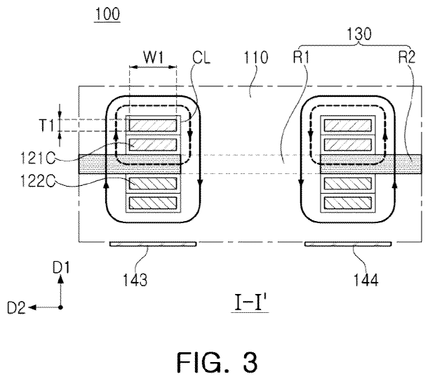

FIG. 1 is a transparent perspective view schematically illustrating a coil component according to a first embodiment of the present disclosure. FIG. 2 is an exploded perspective view of a coil and a coupling adjustment portion in the coil component of FIG. 1. FIG. 3 is a cross-sectional view of the coil component of FIG. 1.

In FIGS. 1 and 2, a coating layer CL on surfaces of first and second wound coils 121 and 122 that may be applied to the first embodiment will be omitted to illustrate coupling between components more clearly.

Referring to FIGS. 1 through 3, a coil component 100 according to the first embodiment may include a body 110, a first wound coil 121, a second wound coil 122, a coupling adjustment portion 130, and first to fourth external electrodes 141, 142, 143 and 144, and may be implemented as an array-type inductor in which the first and second wound coils 121 and 122 are magnetically coupled. In this case, the coupling adjustment portion 130 may include a first region R1 and a second region R2 surrounding the first region R1 in a lateral direction, and the first and second regions R1 and R2 may be implemented to have different magnetic permeability, a degree of coupling of the first and second wound coils 121 and 122 may be appropriately adjusted. Details thereof will be described later, and hereinafter, main elements constituting the coil component 100 of the first embodiment will be described.

The body 110 may have the first and second wound coils 121 and 122 disposed therein, and may form an overall appearance of the coil component 100. In this case, the body 110 may include an upper surface and a lower surface opposing in a first direction D1, and a plurality of side surfaces connecting them. The body 110 may include an insulating resin and a magnetic material. Specifically, the body 110 may be formed by stacking one or more magnetic composite sheets in which a magnetic material is dispersed in an insulating resin. The magnetic material may be ferrite or a metal magnetic powder particle. Examples of the ferrite may include at least one or more spinel type ferrites, such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, and the like, hexagonal ferrites such as Ba—Zn-based ferrite, Ba—Mg-based ferrite, Ba—Ni-based ferrite, Ba—Co-based ferrite, Ba—Ni—Co-based ferrite, and the like, garnet type ferrites such as Y-based ferrite, and the like, and Li-based ferrites. The metal magnetic powder particle may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder particle may be at least one or more of a pure iron powder, a Fe—Si-based alloy powder, a Fe—Si—Al-based alloy powder, a Fe—Ni-based alloy powder, a Fe—Ni—Mo-based alloy powder, a Fe—Ni—Mo—Cu-based alloy powder, a Fe—Co-based alloy powder, a Fe—Ni—Co-based alloy powder, a Fe—Cr-based alloy powder, a Fe—Cr—Si-based alloy powder, a Fe—Si—Cu—Nb-based alloy powder, a Fe—Ni—Cr-based alloy powder, and a Fe—Cr—Al-based alloy powder. The metal magnetic powder particle may be amorphous or crystalline. For example, the metal magnetic powder particle may be a Fe—Si—B—Cr-based amorphous alloy powder particle, but the present disclosure is not limited thereto. The ferrite and the metal magnetic powder particle may have an average diameter of about 0.1 μm to 30 μm, respectively, but are not limited thereto. The body 110 may include two or more types of magnetic materials dispersed in the resin. In this case, the term “different types of magnetic materials” means that magnetic materials dispersed in a resin are distinguishable from each other by at least one of an average diameter, a composition, a crystallinity, or a shape. The insulating resin may include an epoxy, a polyimide, a liquid crystal polymer, or the like, in a single form or in combined form, but the present disclosure is not limited thereto.

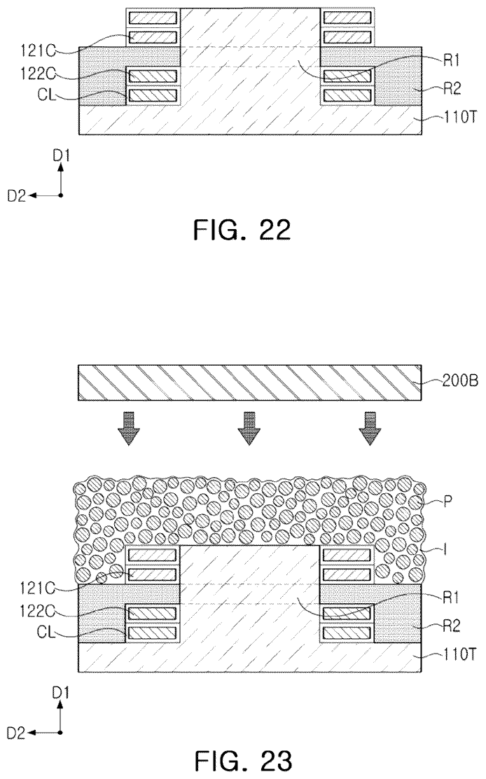

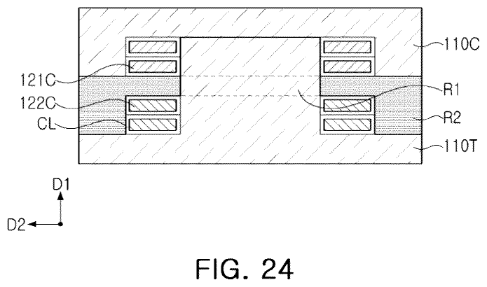

An example of a method for manufacturing the same will be described with reference to FIGS. 21 through 24. First, as illustrated in FIG. 21, a composite material containing a magnetic material and an insulating resin may be filled into a mold having an inverted T-shaped cross-section, and then heated and pressed to form a lower region 110T of a body 110. The lower region 110T of the body 110 formed in this manner may have an inverted T shape with a central portion protruding in an upward direction, which may include a first region R1, and a second wound coil 122 may be disposed such that a winding axis passes through a region protruding as above. Thereafter, magnetic particles P may be applied onto the second wound coil 122 using an inkjet, a dispensing process, or the like, to obtain a magnetic permeability adjustment portion having different magnetic properties from the lower region 110T including the first region R1. In this case, an insulating material I may be interposed between the magnetic particles P, and a solvent, etc. may be further included, as needed. After the magnetic particles P are disposed, the magnetic permeability adjustment portion may be pressed and molded using a mold 200A, and thus a second region R2 of the magnetic permeability adjustment portion may be obtained as illustrated in FIG. 22. Thereafter, a first wound coil 121 may be disposed on the second region R2. Next, as illustrated in FIG. 23, magnetic particles P may be applied onto the first wound coil 121 using an inkjet, a dispensing process, or the like. In this case, an insulating material I may be interposed between the magnetic particles P, and a solvent, etc. may be further included, as needed. After the magnetic particles P are disposed, those including the magnetic particles P and the insulating material I may be pressed and molded using a mold 200B, and thus an upper region 110C of the body may be obtained as illustrated in FIG. 24. By using this manufacturing method, it is possible to efficiently form a magnetic permeability adjustment portion having a first region R1 and a second region R2 having different magnetic properties, between the first wound coil 121 and the second wound coil 122.

As another example of a manufacturing method, the body 110 may be formed using a lamination method. Specifically, a plurality of unit stacks for manufacturing the body 110 may be prepared and stacked on upper and lower portions of the first and second wound coils 121 and 122. In this case, the unit stacks may be prepared as sheet types by mixing a magnetic particle, such as a metal or the like, and an organic material such as a thermosetting resin, a binder, a solvent, or the like, to form a slurry, applying the slurry to a carrier film by a doctor blade method, to a thickness of several tens of μm, and drying the same. Therefore, the unit stacks may be manufactured in a form in which the magnetic particle is dispersed in the thermosetting resin such as an epoxy resin, polyimide, or the like.

Referring again to FIGS. 1 through 3, the first wound coil 121 may be disposed in the body 110, and may include a first coil portion 121C having at least one turn based on the first direction D1 as a winding axis, and first and second lead-out portions 121A and 121B respectively extending from both end portions of the first coil 121C. In addition, the second wound coil 122 may be spaced apart from the first coil portion 121C in the first direction D1 in the body 110, and may include a second coil portion 122C having at least one turn based on the first direction D1 as a winding axis, and third and fourth lead-out portions 122A and 122B respectively extending from both end portions of the second coil portion 122C.

The first coil portion 121C and the second coil portion 122C may form a turn wound in the same direction. Additionally, the first and second lead-out portions 121A and 121B may be drawn out to one side surface of the body 110, and the third and fourth lead-out portions 122A and 122B may be drawn out to another side surface of the body 110. In this case, the one side surface of the body 110 from which the first and second lead-out portions 121A and 121B are drawn out may oppose the other side surface of the body 110 from which the third and fourth lead-out portions 122A and 122B are drawn out.

Referring to FIG. 3, the first and second wound coils 121 and 122 may be formed by winding a conductive metal, and a coating layer CL may be disposed on a surface of a remaining portion, excluding a portion contacting the first to fourth external electrodes 141 to 144. The coating layer CL may include a known material having insulating properties, and may include, for example, a thermoplastic resin such as a polystyrene-based resin, a vinyl acetate-based resin, a polyester-based resin, a polyethylene-based resin, a polypropylene-based resin, a polyamide-based resin, a rubber-based resin, an acrylic-based resin, or the like, a thermosetting resin such as a phenol-based resin, an epoxy-based resin, a urethane-based resin, a melamine-based resin, an alkyd-based resin, or the like, a photosensitive resin, parylene, SiOₓ, or SiNₓ.

Referring to FIG. 3, the first and second coil portions 121C and 122C of the first embodiment may be formed by winding a rectangular wire having a rectangular cross-section, and, on a D1-D2 cross-section, an aspect ratio (T1/W1), which may be a ratio of a thickness T1 to a line width W1 of the first and second coil portions 121C and 122C, may be less than 1.

The line width W1 of the first and second coil portions 121C and 122C may mean, based on an optical microscope image or a scanning electron microscope (SEM) image of the D1-D2 cross-section taken from a central portion of the coil component 100 in a D3-direction, an arithmetic mean value of at least three of values of each of a plurality of line segments, connecting two outermost boundary lines facing in a second direction D2 of each turn of the first and second coil portions 121C and 122C, illustrated in the image, parallel to the second direction D2, and spaced apart from each other in the first direction D1. In this case, the plurality of line segments parallel to the second direction D2 may be equally spaced from each other in the first direction D1, but the scope of the present disclosure is not limited thereto.

The thickness T1 of the first and second coil portions 121C and 122C may mean, based on an optical microscope image or a scanning electron microscope (SEM) image of the D1-D2 cross-section taken from the central portion of the coil component 100 in the D3-direction, an arithmetic mean value of at least three of values of each of a plurality of line segments, connecting two outermost boundary lines facing in the first direction D1 of each turn of the first and second coil portions 121C and 122C, illustrated in the image, parallel to the first direction D1, and spaced apart from each other in the second direction D2. In this case, the plurality of line segments parallel to the first direction D1 may be equally spaced from each other in the second direction D2, but the scope of the present disclosure is not limited thereto.

Examples of materials constituting the first and second wound coils 121 and 122 may include a conductive material such as copper (Cu), aluminum (Al), silver (Ag), tin (Sn), gold (Au), nickel (Ni), lead (Pb), titanium (Ti), chromium (Cr), and alloys thereof, but are not limited thereto.

The first external electrode 141 and the second external electrode 142 may be connected to the first wound coil 121, and, specifically, may be connected to the first lead-out portion 121A and the second lead-out portion 121B, respectively. The third external electrode 143 and the fourth external electrode 144 may be connected to the second wound coil 122, and, specifically, may be connected to the third lead-out portion 122A and the fourth lead-out portion 122B, respectively. In this case, the first external electrode 141 and the second external electrode 142 may be disposed on the same side surface of the body 110, and may extend to a lower surface of the body 110, and similarly, the third external electrode 143 and the fourth external electrode 144 may be disposed on the same side surface of the body 110, and may extend to the lower surface of the body 110.

The first to fourth external electrodes 141 to 144 may be formed using a paste containing metal having excellent electrical conductivity, and the paste may be, for example, a conductive paste containing nickel (Ni), copper (Cu), tin (Sn), or silver (Ag), alone or as an alloy thereof, or the like. Additionally, a plating layer may be provided to cover each of the first to fourth external electrodes 141 to 144. In this case, the plating layer may include one or more selected from the group consisting of nickel (Ni), copper (Cu), and tin (Sn), and, for example, a nickel (Ni) layer and a tin (Sn) layer may be formed sequentially.

Referring to FIGS. 1 through 3, the coupling adjustment portion 130 may be disposed between the first wound coil 121 and the second wound coil 122, and may have the first region R1 and the second region R2 having different magnetic permeability from each other. Each of the first region R1 and the second region R2 may include a plurality of magnetic particles and an insulating material interposed between the plurality of magnetic particles, and magnetic permeability of the first region R1 may be higher than magnetic permeability of the second region R2.

In the coupling adjustment portion 130, the first region R1 may correspond to a region through which winding axis of the first and second coil portions 121C and 122C pass, and the second region R2 may be disposed in a region in which the first and second coil portions 121C and 122C overlap each other in the first direction D1, and in a region outside the first and second coil portions 121C and 122C.

The first and second coil portions 121C and 122C may form a magnetic flux path (solid arrow in FIG. 3) coupled to each other in at least a portion of the first region R1. The second region R2 may be located in at least a portion of regions surrounding the first region R1 in a lateral direction, and has a different magnetic permeability from the first region R1. At least a portion of the second region R2 may be located in a leaked magnetic flux path (dotted arrow in FIG. 3) of each of the first coil portion 121C and the second coil portion 122C. In this manner, the magnetic permeability of the first and second regions R1 and R2 located in the coupled magnetic flux path and the leakage magnetic flux path, respectively, may be changed to effectively control coupling coefficients of the first and second wound coils 121 and 122. For example, when the coupling coefficients of the first and second wound coils 121 and 122 are targeted to be 0.495 or more and less than 0.605, based on an absolute value, it may not be easy to adjust the coupling coefficients by precisely controlling a gap between the first and second wound coils 121 and 122, a magnetic material of the body 110, or the like. Therefore, in the present disclosure, the coupling adjustment portion 130 may be disposed between the first and second wound coils 121 and 122 to implement a target coupling coefficient value, without making the gap between the first and second wound coils 121 and 122 from being too far from each other or too close to each other.

As a specific example, the second region R2 may have lower magnetic permeability than the first region R1. In one embodiment, the first region R1 may form an integrated structure with the body 110. In another embodiment, the first region R1 may be manufactured separately from the body 110, and may be formed of magnetic particles having different types or sizes. As in the first embodiment, by setting the magnetic permeability of the second region R2 to be relatively low, a magnitude of each leakage magnetic flux may be reduced, without excessively reducing the gap between the first and second coil portions 121C and 122C, so that an effect of reducing saturation current (Iₛₐₜ) may be also achieved. Here, the first region R1 may have a relatively high magnetic permeability. If the magnetic permeability of the first region R1 is lowered to a level similar to that of the second region R2, a magnitude of the coupled magnetic flux may be reduced. Therefore, to compensate for this reduction of magnitude of the coupled magnetic flux, it may be necessary to increase the number of turns of the first and second coil portions 121C and 122C or reduce a gap therebetween. As in the first embodiment, the first region R1 may be set to have a relatively high level of magnetic permeability, a magnitude of the coupled magnetic flux may be sufficiently secured, without increasing the number of turns of the first and second coil portions 121C and 122C or excessively reducing the gap therebetween, and therefrom, a target coupling coefficient may be effectively implemented.

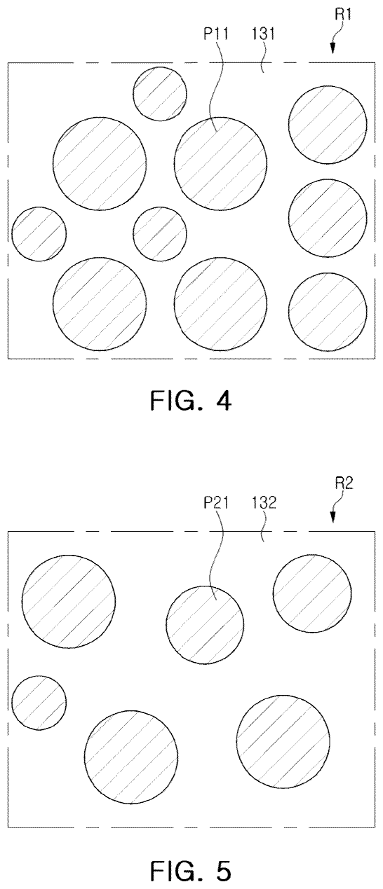

When describing a specific form of the coupling adjustment portion 130, first, as in the first embodiment, the first and second coil portions 121C and 122C may be disposed on first and second surfaces (corresponding to the upper and lower surfaces, respectively, based on the drawings) opposite to each other, in the second region R2 of the coupling adjustment portion 130. In this case, the first and second wound coils 121 and 122 may be supported by the coupling adjustment portion 130. Additionally, the second region R2 of the coupling adjustment portion 130 may extend to one side surface of the body 110. Therefore, the second region R2 may be disposed outside of the first and second coil portions 121C and 122C in the lateral direction (e.g., D2). In this manner, the second region R2, which has a relatively low magnetic permeability in the coupling adjustment portion 130, may be disposed in a region corresponding to a space between the first and second coil portions 121C and 122C, and in an outer region of the first and second coil portions 121C and 122C in the lateral direction, a magnitude of leakage magnetic flux of the first and second wound coils 121 and 122 may be effectively reduced. In the coupling adjustment portion 130 according to one embodiment, magnetic permeability of the first region R1 may be different from magnetic permeability of the second region R2. For example, the magnetic permeability of the second region R2 may be lower than the magnetic permeability of the first region R1. When it is difficult to measure the magnetic permeability for each region in a state of the coil component 100, a type of magnetic material, a particle size, a packing rate, etc. included in the first region R1 and the second region R2 may be analyzed to compare magnetic permeability thereof. Hereinafter, a configuration in which magnetic permeability of the first region R1 and magnetic permeability of the second region R2 are adjusted will be described with reference to FIGS. 4 through 8, and a packing rate of magnetic particles in the second region R2 may be adjusted to be lower than a packing rate of magnetic particles in the first region R1.

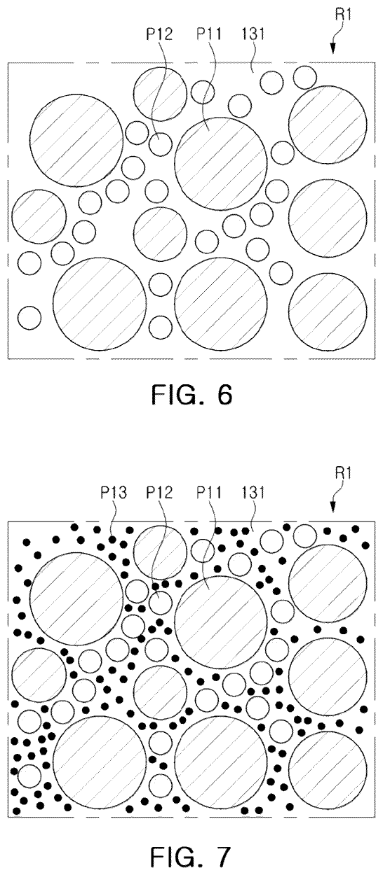

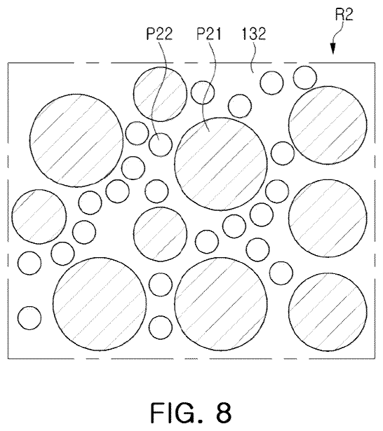

FIG. 4 is an enlarged cross-sectional view of a first region of a coupling adjustment portion. FIG. 5 is an enlarged cross-sectional view of a second region of a coupling adjustment portion. FIG. 6 is an enlarged cross-sectional view of a first region of a coupling adjustment portion in a modified example. FIG. 7 is an enlarged cross-sectional view of a first region of a coupling adjustment portion in a modified example. FIG. 8 is an enlarged cross-sectional view of a second region of a coupling adjustment portion in a modified example.

First, referring to FIGS. 4 and 5, a first region R1 may include magnetic particles P11, and an insulating material 131 such as a resin or the like may be interposed between the magnetic particles P11. Likewise, a second region R2 may include magnetic particles P21, and an insulating material 132 such as a resin or the like may be interposed between the magnetic particles P21. As illustrated, a packing rate of the magnetic particles P11 in the first region R1 may be higher than a packing rate of the magnetic particles P21 in the second region R2. As an example of a method of obtaining the packing rate, after obtaining SEM images of the first region R1 and the second region R2, a ratio of an area occupied by the magnetic particles (P11 or P21) relative to a total area may be calculated. In this case, to obtain more accurate values, values for the packing rate may be obtained from a plurality of cross-sections and an average value may be obtained therefrom.

When there may be no significant difference in size of the magnetic particles P11 and P21 in the first region R1 and the second region R2, for example, when a difference between D50 of the magnetic particle P11 in the first region R1 and D50 of the magnetic particles P21 of the second region R2 is 10% or less, the packing rates of the magnetic particles P11 and P21 may affect magnetic permeability in a region corresponding thereto. In this case, the difference in D50 being 10% or less means that a ratio of difference between large and small values of D50 relative to the large value of D50 is 10% or less. As an example, the magnetic particles P11 included in the first region R1 may have a diameter range of 5 to 61 μm, and similarly, the magnetic particles P21 included in the second region R2 may have a diameter range of 5 to 61 μm.

To increase a packing rate of magnetic particles, magnetic particles having different particle size distributions may be used. For example, the first region R1 may include two or more types of magnetic particles having different sizes of D50. FIG. 6 illustrates an example using two types of particles (P11 and P12), and FIG. 7 illustrates an example using three types of particles (P11, P12, and P13). Additionally, FIG. 8 illustrates an example in which a second region R2 includes two types of magnetic particles P21 and P22 having different sizes of D50.

For the number of types of magnetic particles in terms of different sizes of D50, the second region R2 may have a smaller number of types of the magnetic particles than the first region R1. As a non-limiting example, the first region R1 may include two or more types of magnetic particles (P11 and P12) of different sizes, and the second region R2 may include a single type of magnetic particle (P21). As another example, the first region R1 may include three or more types of magnetic particles (P11, P12, and P13) of different sizes, and the second region R2 may include two or less types of magnetic particles (P21 and P22) of different sizes.

As such, a plurality of magnetic particles with different sizes of D50 may be used to improve a packing rate of the magnetic particles, and thus magnetic permeability of a region corresponding thereto may increase. In this case, first magnetic particles P11 included in the first region R1 may have a diameter range of 5 to 61 μm, second magnetic particles P12 may have a diameter range of 0.9 to 4.5 μm, and third magnetic particles P13 may have a diameter range of 10 to 800 nm. Additionally, first magnetic particles P21 included in the second region R2 may have a diameter range of 5 to 61 μm, and second magnetic particles P22 may have a diameter range of 0.9 to 4.5 μm.

Unlike the above embodiment, the first region R1 may include three types of magnetic particles, and the second region R2 may include one type of magnetic particle. As another example, the first region R1 may include two types of magnetic particles, and the second region R2 may include one type of magnetic particle.

Diameters of the magnetic particles (P11 to P13, P21, and P22) present in the coupling adjustment portion 130 may be measured from a cross-section of the coupling adjustment portion 130. Specifically, after photographing a plurality of equally spaced regions (e.g., 5 or 10 regions) in the second direction D2 or the like with respect to a D1-D3 cross-section passing through a center of the body 110 with a scanning electron microscope (SEM), the diameters of magnetic particles (P11 to P13, P21, and P22) may be obtained using an analysis program. In this case, as a specific example, an image pixel size in an SEM image may be fixed to 10 nm*10 nm, and a working distance may be fixed to 8 mm. A back scattered mode may be used. Afterwards, an average value of diameters may be calculated using an image analysis program (e.g., a deep learning tool from ORS company). The magnetic particles (P11 to P13, P21, and P22) may have a spherical shape or a substantially spherical shape, but are not limited thereto. For example, the magnetic particles (P11 to P13, P21, and P22) may have a non-spherical shape. These shapes may be obtained as sphericity of the magnetic particles (P11 to P13, P21, and P22) decreases during an oxidation process. When the magnetic particles (P11 to P13, P21, and P22) have any shape that does not maintain a spherical shape, the above-mentioned diameter may be interpreted as being replaced with Feret diameter, and an average value of diameters may be also interpreted as being replaced with an average value of Feret diameters. As a method of calculating the average diameter value, a tool in image process software may be used, and a size distribution may be obtained by particle size analysis for each area. In the above explanation, diameters of the magnetic particles (P11 to P13, P21, and P22) may be measured by taking a plurality of cross-sections from the magnetic component, but when it is difficult to take a plurality of cross-sections, the diameters of the magnetic particles may also be measured on one cross-section, for example, a D1-D3 cross-section, a D1-D2 cross-section, or the like, passing through the center of the body 110.

In the above embodiment, the magnetic permeability of the coupling adjustment portion 130 of the magnetic particles was changed, and for this purpose, a packing rate in each region was adjusted. In contrast, the first and second regions R1 and R2 may have different materials constituting the magnetic particles, and thereby the magnetic permeability may be adjusted. Specifically, the coupling adjustment portion 130 may include an Fe-based alloy, and, in this case, an Fe-based alloy included in the first region R1 and an Fe-based alloy included in the second region R2 may have different compositions. In this case, an Fe amount of the Fe-based alloy included in the first region R1 may be higher than an Fe amount of the Fe-based alloy included in the second region R2, and the Fe amounts may be wt %. Additionally, considering that Si, in addition to Fe, also affects magnetic permeability, an Si amount may also be adjusted together with or independently of Fe. For example, the Fe-based alloy included in the coupling adjustment portion 130 may be an Fe—Si-based alloy, and an Si amount of an Fe—Si-based alloy included in the first region R1 may be higher than an Si amount of an Fe—Si-based alloy included in the second region R2. Specifically, the Si amount in the Fe—Si-based alloy included in the first region R1 may be 6.5 wt % or more, and the Si amount in the Fe—Si-based alloy included in the second region R2 may be less than 6.5 wt %. More specifically, the Si amount in the Fe—Si-based alloy included in the second region R2 may be 1 wt % or more and 5 wt % or less. Additionally, when the Fe-based alloy included in the first region R1 and the Fe-based alloy included in the second region R2 have different compositions, types of elements included therein may be different. For example, elements included in the Fe-based alloy of the first region R1 may not be included in the Fe-based alloy of the second region R2, and vice versa.

Unlike the previous embodiment, it is also possible to implement the second region R2 in the coupling adjustment portion 130, as a sheet, rather than as a magnetic particle. For example, the second region R2 may include a magnetic sheet, and, in this case, the magnetic sheet may include ferrite. In this case, the first region R1 may include magnetic particles formed of an Fe-based alloy that has a relatively higher magnetic permeability than ferrite.

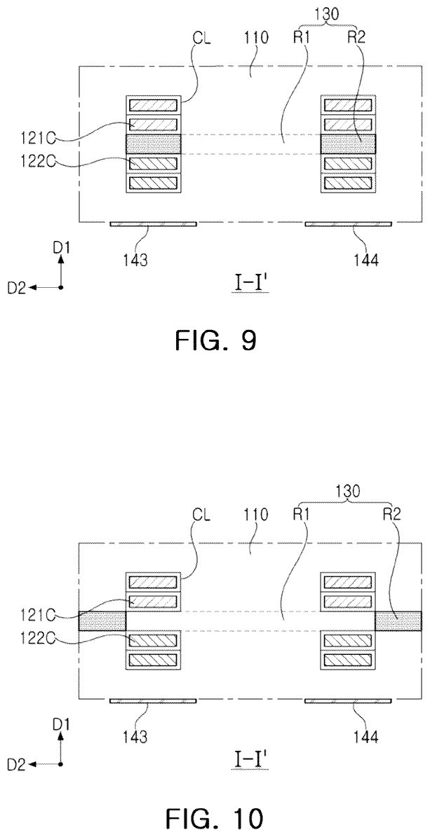

A region in which the coupling adjustment portion 130 is formed may be changed, depending on a magnitude of a desired coupling coefficient or other characteristics, and this will be explained with reference to modified examples of FIGS. 9 through 15. First, as in the modified example of FIG. 9, a second region R2 of a coupling adjustment portion 130 may be implemented as a configuration surrounded by a body 110 in the lateral direction. In this case, the second region R2 may be limitedly formed in a region in which first and second coil portions 121C and 122C are formed, and may not be formed outside the first and second coil portions 121C and 122C in the lateral direction. When the coupling adjustment portion 130 has this arrangement, a magnitude of coupled magnetic flux of first and second wound coils 121 and 122 outside the first and second coil portions 121C and 122C may increase.

Next, as in the modified example of FIG. 10, a coupling adjustment portion 130 may have a configuration in which a first region R1 is expanded. For example, the first region R1 may be extended into a region in which first and second coil portions 121C and 122C overlap in the first direction D1. In this case, a second region R2 may be limited to the outside of the region in which the first and second coil portions 121C and 122C overlap in the first direction D1.

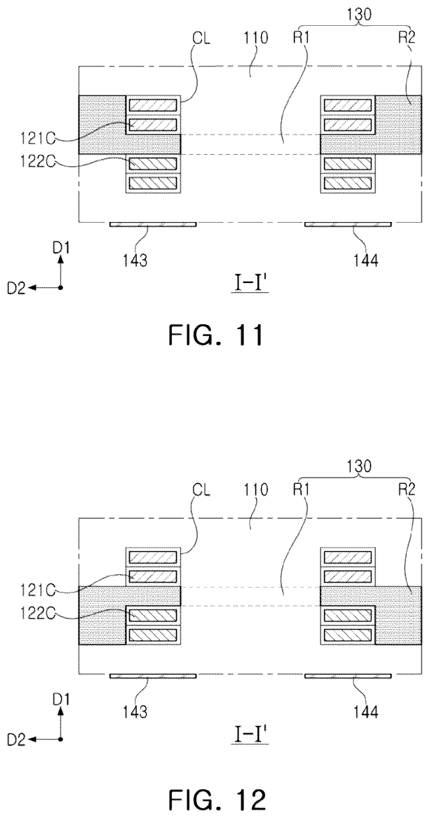

Next, referring to FIG. 11, a second region R2 of a coupling adjustment portion 130 may be disposed to cover at least a portion of a side surface of a first coil portion 121C. Additionally, the second region R2 of the coupling adjustment portion 130 may be disposed to be spaced apart from a side surface of a second coil portion 122C. When the coupling adjustment portion 130 has this arrangement, it may be finely adjusted to close to a desired coupling coefficient by reducing leakage magnetic flux flowing around the outside of the first coil portion 121C.

Next, referring to FIG. 12, a second region R2 of a coupling adjustment portion 130 may be disposed to cover at least a portion of a side surface of a second coil portion 122C. Additionally, the second region R2 of the coupling adjustment portion 130 may be disposed to be spaced apart from a side surface of a first coil portion 121C. When the coupling adjustment portion 130 has this arrangement, it may be finely adjusted to close to a desired coupling coefficient by reducing leakage magnetic flux flowing around the outside of the second coil portion 122C.

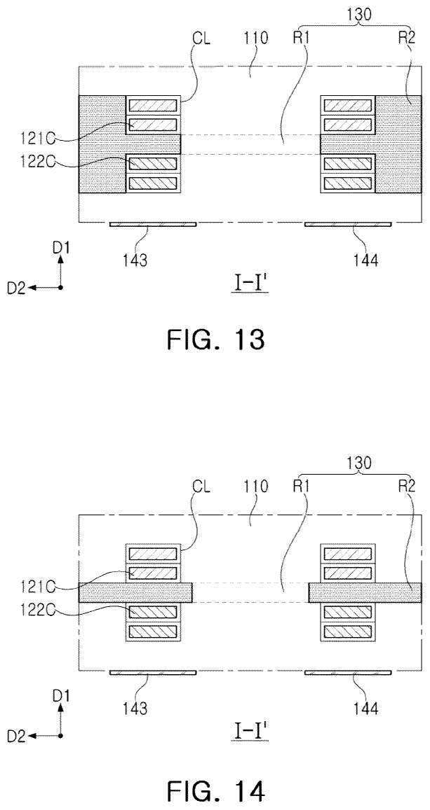

Next, referring to FIG. 13, a second region R2 of a coupling adjustment portion 130 may be disposed to cover at least a portion of a side surface of a first coil portion 121C and at least a portion of a side surface of a second coil portion 122C. For example, the second region R2 of the coupling adjustment portion 130 may extend toward an upper or lower surface of a body 110 along the side surfaces of the first and second coil portions 121C and 122C in a region outside the first and second coil portions 121C and 122C. When the coupling adjustment portion 130 has this arrangement, it may be finely adjusted to close to a desired coupling coefficient by reducing leakage magnetic flux flowing around the outside of the first and second coil portions 121C and 122C.

Next, referring to FIG. 14, a second region R2 of a coupling adjustment portion 130 may be disposed to protrude inwardly from inner surfaces of the first and second coil portions 121C and 122C toward the winding axis of first and second coil portions 121C and 122C. For example, the second region R2 of the coupling adjustment portion 130 may be implemented as partially extending in a direction toward central cores of the first and second coil portions 121C and 122C. When the coupling adjustment portion 130 has this arrangement, it may be finely adjusted to close to a desired coupling coefficient by reducing leakage magnetic flux flowing between the first and second coil portions 121C and 122C.

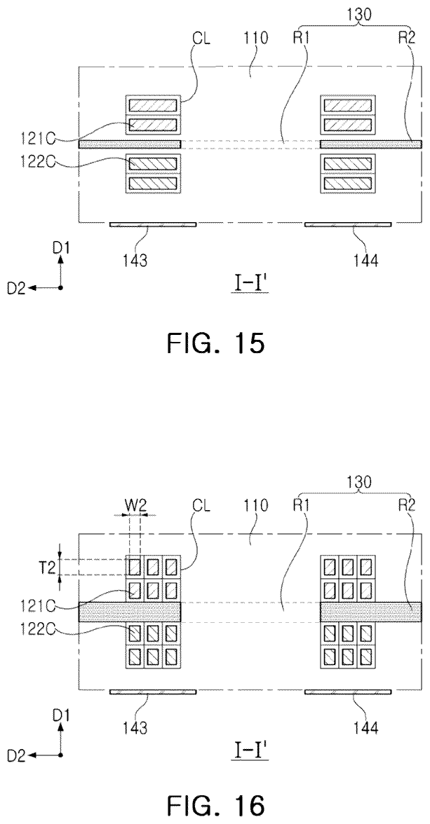

Referring to FIG. 15, a second region R2 of a coupling adjustment portion 130 may be disposed to be spaced apart from lower and upper surfaces of first and second coil portions 121C and 122C, respectively. For example, the second region R2 of the coupling adjustment portion 130 may be formed to have a relatively thin thickness in the first direction D1, to be respectively spaced apart from the first and second coil portions 121C and 122C, while keeping a distance between the first and second coil portions 121C and 122C constant. When the coupling adjustment portion 130 has this arrangement, coupling coefficient may be adjusted and a volume of the second region R2 having low magnetic permeability may be reduced, to improve saturation current (Iₛₐₜ) of a coil component 300′.

Hereinafter, embodiments that differ in specific form of the wound coils 121 and 122 from the previous embodiment will be described. Even without specific explanation, all of the preceding embodiments may also be applied to the following modified examples.

In an example of FIG. 16, first and second coil portions 121C and 122C may be formed by winding a rectangular wire having a rectangular cross-section, and, on a D1-D2 cross-section, an aspect ratio (T2/W2), which may be a ratio of a thickness T2 to a line width W2 of the first and second coil portions 121C and 122C, may be 1 or more. Specifically, each of the first and second coil portions 121C and 122C of the present embodiment may be wound to form at least one turn around a winding axis parallel to the first direction D1 using a rectangular metal wire having a cross-sectional aspect ratio of 1 or more. As an example, each of the first and second coil portions 121C and 122C may include a first layer wound from the outside to the inside for 3 turns, and a second layer extending from the first layer and wound from the inside to the outside for 3 turns, but is not limited thereto.

When the first and second wound coils 121 and 122 have this shape, it may be easy to increase the number of turns in a limited space of the body 110, thereby improving inductance capacity.

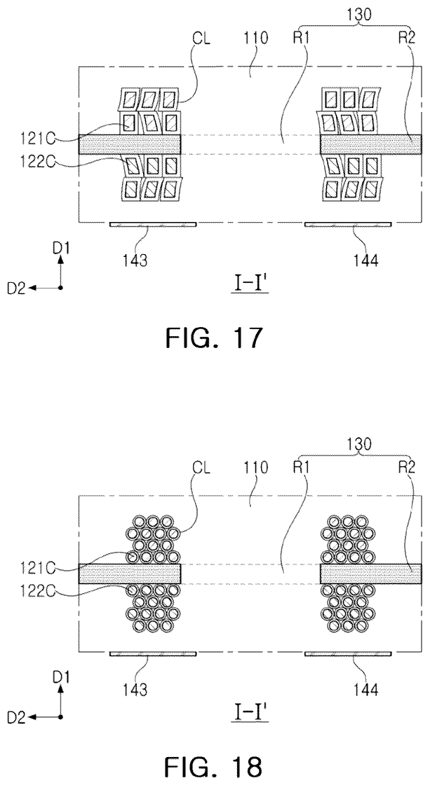

Next, in an example of FIG. 17, first and second coil portions 121C and 122C may partially include an inclined shape in the first direction D1. For example, the first and second coil portions 121C and 122C forming turns in first and second wound coils 121 and 122 may partially include turns having a skewed cross-sectional shape to a left or right side, based on a D1-D2 cross-section of each turn.

Next, in an example of FIG. 18, first and second coil portions 121C and 122C may be formed in a circular shape on a D1-D2 cross-section. In addition, according to this, a coating layer CL that coats surfaces of the first and second coil portions 121C and 122C with an insulating material may also have a circular shape in the D1-D2 cross-section. When first and second wound coils 121 and 122 have this shape, it may be easy to increase the number of turns in a limited space of the body 110, thereby improving inductance capacity. In addition, the number of turns and a degree of design freedom of drawing direction of the first and second wound coils 121 and 122 may be high, and may be thus adjusted to be close to a desired coupling coefficient.

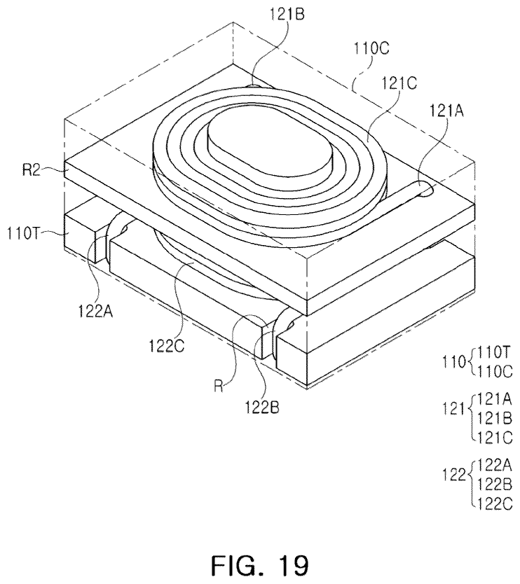

Next, in an example illustrated in a transparent perspective view of FIG. 19, there may be a difference in method of connecting wound coils 121 and 122 to an external electrode. Specifically, a second wound coil 122 may be disposed on a lower region 110T of a body 110, and lead-out portions 122A and 122B of the second wound coil 122 may be disposed in a groove R formed in the lower region 110T. In this case, the lead-out portions 122A and 122B of the second wound coil 122 may be bent and disposed on a lower surface of the lower region 110T, and for this purpose, an additional groove may be formed on the lower surface of the lower region 110T. A second region R2 of a magnetic permeability adjustment portion 130 may be disposed on the second wound coil 122, and a first wound coil 121 may be disposed on the second region R2 of the magnetic permeability adjustment portion 130. Similar to the second wound coil 122, lead-out portions 121A and 121B of the first wound coil 121 may be disposed in the groove R formed in the lower region 110T. In this case, the lead-out portions 121A and 121B of the first wound coil 121 may be bent and disposed on the lower surface of the lower region 110T, and for this purpose, an additional groove may be formed on the lower surface of the lower region 110T. As illustrated, the lead-out portions 121A and 121B of the first wound coil 121 may pass through the second region R2. An upper region 110C of the body 110 may be disposed on the first wound coil 121.

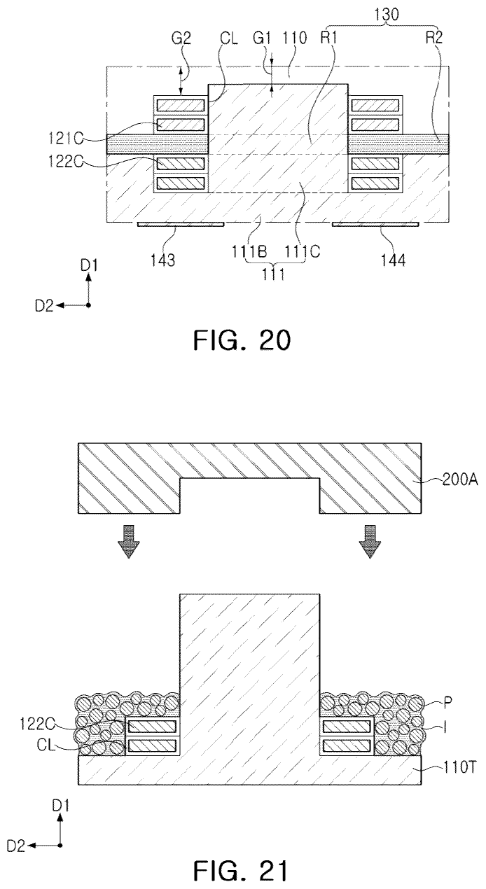

Next, in an example of FIG. 20, a body 110 may include a mold portion 111 in which first and second wound coils 121 and 122 are disposed and protruding toward an upper surface of the body 110. The mold portion 111 may be an element included in the body 110, and may be formed by filling a mold having an inverted T-shaped cross-section with a composite material containing a magnetic material and an insulating resin and then heating and pressing the same, but is not limited thereto. The mold portion 111 may include a base portion 111B on which the second wound coil 122 is directly disposed, and a core portion 111C protruding from the base portion 111B and passing through centers of first and second coil portions 121C and 122C. A gap G1 between the core portion 111C and the upper surface of the body 110 may be narrower than the gap G2 between the first coil portion 121C and the upper surface of the body 110. For example, the core portion 111C may be implemented as a configuration protruding from an upper surface of the first coil portion 121C. When the mold portion 111 has this shape, it is possible to stably support the first and second wound coils 121 and 122, and when stacking magnetic sheets or filling a magnetic material on the body 110, deformation of the first and second wound coils 121 and 122 may be prevented.

For convenience of explanation, although a solid boundary line is illustrated between a region of the mold portion 111 and a remaining region in the body 110, and a dashed boundary line is illustrated between a region of the base portion 111B and a region of the core portion 111C in the mold portion 111, the scope of the present disclosure is not limited thereto, and since each component of the body 110 may be integrated, no interface may be formed therebetween.

A coil component according to an example of the present disclosure may be suitable for effectively implementing a target coupling coefficient and may improve characteristics such as saturation current (Iₛₐₜ) or the like.

While example embodiments have been illustrated and described above, it will be apparent to those skilled in the art that modifications and variations could be made without departing from the scope of the present disclosure as defined by the appended claims.

What is claimed is:

1. A coil component comprising:
a body having an upper surface and a lower surface, opposite to each other, in a first direction, and a side surface connecting the upper surface and the lower surface;
a first wound coil disposed in the body, and including a first coil portion having at least one turn, and first and second lead-out portions respectively extending from both end portions of the first coil portion;
a second wound coil disposed in the body, spaced apart from the first wound coil in the first direction, and including a second coil portion having at least one turn, and third and fourth lead-out portions respectively extending from both end portions of the second coil portion;
a coupling adjustment portion having a portion disposed between the first and second wound coils, and including a first region through which a winding axis of the first coil portion and a winding axis of the second coil portion pass, and a second region surrounding the first region in a lateral direction which is different from the first direction;
first and second external electrodes respectively connected to the first and second lead-out portions; and
third and fourth external electrodes respectively connected to the third and fourth lead-out portions,
wherein the first region and the second region include a plurality of magnetic particles and an insulating material interposed between the plurality of magnetic particles, respectively, and
magnetic permeability of the first region is different from magnetic permeability of the second region.

2. The coil component of claim 1, wherein the magnetic permeability of the first region is higher than the magnetic permeability of the second region.

3. The coil component of claim 1, wherein a packing rate of the magnetic particles of the first region is higher than a packing rate of the magnetic particles of the second region.

4. The coil component of claim 1, wherein a difference in D50 value between the magnetic particles in the first region and the magnetic particles in the second region is 10% or less.

5. The coil component of claim 1, wherein the first region includes a first magnetic particle having a diameter range of 5 to 61 μm, a second magnetic particle having a diameter range of 0.9 to 4.5 μm, and a third magnetic particle having a diameter range of 10 to 800 nm, and
the second region includes a first magnetic particle having a diameter range of 5 to 61 μm, and a second magnetic particle having a diameter range of 0.9 to 4.5 μm.

6. The coil component of claim 1, wherein the first region is integrated with the body.

7. The coil component of claim 1, wherein the second region covers at least a portion of a side surface of the first coil portion.

8. The coil component of claim 1, wherein the second region is spaced apart from a side surface of the first coil portion.

9. The coil component of claim 1, wherein the second region covers at least a portion of a side surface of the second coil portion.

10. The coil component of claim 1, wherein the second region is spaced apart from a side surface of the second coil portion.

11. The coil component of claim 1, wherein the second region covers at least a portion of a side surface of the first coil portion and at least a portion of a side surface of the second coil portion.

12. The coil component of claim 1, wherein the second region is disposed outside of the first coil portion and the second coil portion.

13. The coil component of claim 1, wherein the second region extends to the side surface of the body.

14. The coil component of claim 1, wherein the second region is disposed in a region in which the first and second coil portions overlap in the first direction.

15. The coil component of claim 1, wherein the second region protrudes from inner surfaces of the first and second coil portions toward the winding axis of the first and second coil portions.

16. The coil component of claim 1, wherein, on a cross-section parallel to the first direction, the first and second coil portions have an aspect ratio of less than 1.

17. The coil component of claim 1, wherein, on a cross-section parallel to the first direction, the first and second coil portions have an aspect ratio of 1 or more.

18. The coil component of claim 1, wherein, on a cross-section parallel to the first direction, the first and second coil portions are circular.

19. The coil component of claim 1, wherein, on a cross-section parallel to the first direction, the first and second coil portions are rectangular.

20. The coil component of claim 1, wherein, on a cross-section parallel to the first direction, some of the first and second coil portions have a skewed cross-sectional shape to a left or right side with respect to the first direction.

21. The coil component of claim 1, wherein the second region is spaced apart from respective lower and upper surfaces of the first and second coil portions in the first direction.

22. The coil component of claim 1, wherein the body comprises a mold portion in which the first and second wound coils are disposed and protrudes toward the upper surface of the body.

23. The coil component of claim 1, wherein the mold portion comprises a base portion on which the second wound coil is directly disposed, and a core portion protruding from the base portion and penetrating central portions of the first and second coil portions, and
a gap between the core portion and the upper surface of the body is narrower than a gap between the first coil portion and the upper surface of the body.

24. A coil component comprising:
a body having an upper surface and a lower surface, opposite to each other, in a first direction, and a side surface connecting the upper surface and the lower surface;
a first wound coil disposed in the body, and including a first coil portion having at least one turn, and first and second lead-out portions respectively extending from both end portions of the first coil portion;
a second wound coil disposed in the body, spaced apart from the first wound coil in the first direction, and including a second coil portion having at least one turn, and third and fourth lead-out portions respectively extending from both end portions of the second coil portion;
a coupling adjustment portion having a portion disposed between the first and second wound coils, and including a first region through which a winding axis of the first coil portion and a winding axis of the second coil portion pass, and a second region surrounding the first region in a lateral direction which is different from the first direction;
first and second external electrodes respectively connected to the first and second lead-out portions; and
third and fourth external electrodes respectively connected to the third and fourth lead-out portions,
wherein the first region and the second region include magnetic particles, and
a packing rate of the magnetic particles of the first region is different from a packing rate of the magnetic particles of the second region.

25. The coil component of claim 24, wherein the packing rate of the magnetic particles of the first region is higher than the packing rate of the magnetic particles of the second region.

26. The coil component of claim 24, wherein the number of types of the magnetic particles included in the first region is greater than the number of types of magnetic particles included in the second region.

27. The coil component of claim 24, wherein the first region is integrated with the body.

28. The coil component of claim 24, wherein the second region covers a side surface of the first coil portion and at least a portion of a side surface of the second coil portion.

29. The coil component of claim 24, wherein the second region is disposed outside of the first coil portion and the second coil portion.

30. The coil component of claim 24, wherein the second region protrudes from inner surfaces of the first and second coil portions toward the winding axis of the first and second coil portions.

31. A coil component comprising:
a body having an upper surface and a lower surface, opposite to each other, in a first direction, and a side surface connecting the upper surface and the lower surface;
a first wound coil disposed in the body, and including a first coil portion having at least one turn, and first and second lead-out portions respectively extending from both end portions of the first coil portion;
a second wound coil disposed in the body, spaced apart from the first wound coil in the first direction, and including a second coil portion having at least one turn, and third and fourth lead-out portions respectively extending from both end portions of the second coil portion;
a coupling adjustment portion having a portion disposed between the first and second wound coils, and including a first region through which a winding axis of the first coil portion and a winding axis of the second coil portion pass, and a second region surrounding the first region in a lateral direction which is different from the first direction;
first and second external electrodes respectively connected to the first and second lead-out portions; and
third and fourth external electrodes respectively connected to the third and fourth lead-out portions,
wherein the coupling adjustment portion includes an Fe-based alloy, and
a composition of the Fe-based alloy included in the first region is different from a composition of the Fe-based alloy included in the second region.

32. The coil component of claim 31, wherein an Fe amount of the Fe-based alloy included in the first region is higher than an Fe amount of the Fe-based alloy included in the second region.

33. The coil component of claim 32, wherein the Fe-based alloy is an Fe—Si-based alloy, and
an Si amount of the Fe—Si-based alloy included in the first region is higher than an Si amount of the Fe—Si-based alloy included in the second region.

34. The coil component of claim 33, wherein the Si amount in the Fe—Si-based alloy included in the first region is 6.5 wt % or more, and the Si amount in the Fe—Si-based alloy included in the second region is less than 6.5 wt %.

35. The coil component of claim 34, wherein the Si amount of the Fe—Si-based alloy included in the second region is 1 wt % or more and 5 wt % or less.

36. A coil component comprising:
a body;
a first wound coil disposed in the body, and including a first coil portion having at least one turn, and first and second lead-out portions respectively extending from both end portions of the first coil portion;
a second wound coil disposed in the body, spaced apart from the first wound coil in the first direction, and including a second coil portion having at least one turn, and third and fourth lead-out portions respectively extending from both end portions of the second coil portion;
a coupling adjustment portion having a portion disposed between the first and second wound coils, and including a first region through which a winding axis of the first coil portion and a winding axis of the second coil portion pass, and a second region surrounding the first region in a lateral direction which is different from the first direction;
first and second external electrodes respectively connected to the first and second lead-out portions; and
third and fourth external electrodes respectively connected to the third and fourth lead-out portions,
wherein the first region and the second region include magnetic particles, and
wherein the number of types of the magnetic particles included in the first region is greater than the number of types of magnetic particles included in the second region.

37. The coil component of claim 36, wherein magnetic permeability of the first region is higher than magnetic permeability of the second region.

38. The coil component of claim 36, wherein a packing rate of the magnetic particles of the first region is higher than a packing rate of the magnetic particles of the second region.

39. A coil component comprising:
a magnetic body;
a first wound coil disposed in the magnetic body, and including a first coil portion having at least one turn, and first and second lead-out portions respectively extending from both end portions of the first coil portion;
a second wound coil disposed in the magnetic body, spaced apart from the first wound coil in the first direction, and including a second coil portion having at least one turn, and third and fourth lead-out portions respectively extending from both end portions of the second coil portion;
first and second external electrodes respectively connected to the first and second lead-out portions; and
third and fourth external electrodes respectively connected to the third and fourth lead-out portions,
wherein magnetic permeability in a central region of the magnetic body through which a winding axis of the first coil portion and a winding axis of the second coil portion pass is greater than magnetic permeability in at least one of a gap region between the first and second wound coils in the first direction or an outer region of the first and second wound coils in a lateral direction different from the first direction.

40. The coil component of claim 39, wherein the magnetic body includes a plurality of magnetic particles, and
a packing rate of the magnetic particles of the central region is higher than a packing rate of the magnetic particles of at least one of the gap region or the outer region.

41. The coil component of claim 39, wherein the magnetic permeability in the central region is greater than the magnetic permeability of the gap region.

42. The coil component of claim 39, wherein the magnetic permeability in the central region is greater than the magnetic permeability of the outer region.

43. The coil component of claim 39, wherein the magnetic permeability in the central region is greater than the magnetic permeability of the gap region and the magnetic permeability of the outer region.
